(19) United States
(12) Patent Application Publication
(10) Pub. No.: US 2022/0320810 A1
(43) Pub. Date: Oct. 6, 2022

(54) DEVICE FOR THE WIRELESS TRANSMISSION OF A SIGNAL

(71) Applicant: Seepex GmbH, Bottrop (DE)

(72) Inventors: Matthias Janssen, Ratingen (DE); Michael Spengler, Hamminkeln (DE)

(21) Appl. No.: 17/843,610

(22) Filed: Jun. 17, 2022

Related U.S. Application Data
(63) Continuation of application No. PCT/EP2020/080106, filed on Oct. 27, 2020.

(30) Foreign Application Priority Data
Dec. 20, 2019 (DE) 102019135635.0

(51) Int. Cl. H01R 31/06; F04C 28/28; F04C 2/16; G08C 17/02; H04Q 9/00; G08B 7/06

(52) U.S. Cl. CPC H01R 31/065; F04C 28/28; F04C 2/16; G08C 17/02; H04Q 9/00; G08B 7/06; H04Q 2209/40

(57) ABSTRACT

The disclosure relates to a device for the wireless transmission of a signal transmitted from a sensor to a supply apparatus (for example a control system) via at least one line, having electrical connections for the line and having an electronic transmitter apparatus that has an electronic circuit for tapping the signal and a transmitter with which the tapped signal can be wirelessly transmitted. The device is in the form of a plug adapter that has a plug housing, wherein a first plug part and a second plug part are attached to the plug housing, wherein the first plug part is connected to the second plug part via at least one signal conductor arranged within the plug housing for wired transmission of the signal, and wherein the electronic transmitter apparatus is arranged in the plug housing in order to tap off the signal.

### CROSS-REFERENCE TO RELATED APPLICATIONS

This non-provisional U.S. patent application is a continuation of International Patent Application No. PCT/EP/2020/080106, entitled “DEVICE FOR THE WIRELESS TRANSMISSION OF A SIGNAL”, filed Oct. 27, 2020, which claims priority to German Patent Application No. DE 102019135635 A, filed on Dec. 12, 2019, the disclosures of which are incorporated herein by reference in their entirety for all purposes.

### BACKGROUND OF THE INVENTION

The disclosure relates to a device for the wireless transmission of an (analogue or digital) signal transferred from a transmitter to a supply apparatus (for the transmitter) via at least one line (wired), with electrical connections (for the line) and with an electronic transmitting apparatus, which has an electronic circuit for tapping the signal from the line and a transmitter, with which the tapped signal can be wirelessly transmitted.

The supply apparatus, to which the sensor is connected by wire, supplies it with power. It can be a simple measuring apparatus with an indicator for the values determined with the sensor. However, the supply apparatus can also be a control system, for example a machine control system of a machine, for example a pump control system of a pump. The sensor is connected by wire or by cable to the control apparatus. Cabled or wired transfer between sensors and control systems is usually advantageous for industrial applications, because the signals are transferred at high speeds, so that real-time control in particular can be realised.

Regardless of the cabled signal transfer known in principle, in practice there is a need to additionally tap the signals wirelessly in order to not only make the measured values available to the control system (wired), but also to be able to display them on PCs, tablets or smartphones for information purposes, for example, and to make the data available via the Internet (for example via a cloud) where appropriate.

For this purpose, radio modules or telemetry modules are made available in practice, which modules have electrical connections with which they can be connected to the measuring apparatuses on the one hand and to the control system on the other hand, so that the measurement signals are fed through such a telemetry module and tapped there from an electronic circuit. The modules are equipped with corresponding electronic components, in particular an electronic circuit for tapping the signal and a transmitter or a radio chip, with which the tapped signal is transmitted wirelessly (via an antenna) by radio or the like. For example, it is known to use such telemetry modules for loop-powered two-conductor sensors with 4 to 20 mA, without the need for an additional current supply or battery within the module, since the module is powered via the current loop of the sensor. In practice, these known telemetry modules have proven useful in principle. However, they require a certain outlay on wiring.

A method and a device for monitoring pump installations are known, moreover, from DE 10 2004 028 643 B3.

DE 10 2015 205 370 A1 describes a method and a device for providing data for condition monitoring of a machine.

Furthermore, a signal transfer between at least two electrical appliances via adapter plugs is known from DE 20 2009 007 023 U1. In this case, data are sent via the current flowing through the plug. For this purpose, characteristics of the current supply are recorded via a sensor in the plug, in order to send them.

DE 10 2015 205 379 A1 discloses a device for determining power management data in an automation installation, which can be configured as a measuring appliance or as a measuring kit. In the automation installation, a sensor can be connected to a control apparatus, for example to a programmable logic controller, via a sensor line. The device described can be interconnected into the sensor line, that is to say in terms of circuitry or signalling between the sensor and the control apparatus. In this case, the device acts in particular as a so-called data splitter or data splicer, were the sensor values are provided at two data outputs, specifically once for the control apparatus and on the other hand additionally at a communication interface. The device described in this publication is also referred to as a “listening box”, the connections of which are identical to or correspond to the electrical connections of the sensor or of the PLC and can be formed, for example, as M12 plugs. An external current supply is always provided.

### SUMMARY OF THE INVENTION

Starting from the previously known prior art, the disclosure is based on the problem of creating a device for the wireless transmission of a signal of the type described at the beginning, which is not only simply and compactly constructed, but which in particular can be integrated very easily and without cabling outlay in lines between electrical or electronic apparatuses (a sensor and a control system, for example). In particular, it should be possible thereby to tap signals from existing (mechanical) installations, pump installations for example, and transfer them wirelessly without the need for complex conversions or new cabling.

To solve this problem, the disclosure teaches, in the case of a generic device of the type described at the beginning,

that the device is formed as an adapter plug, which has a plug housing,

wherein a first plug part and a second plug part are attached to the plug housing,

wherein the first plug part is connected to the second plug part at least one signal conductor arranged within the plug housing for wired transfer of the signal,

wherein the electronic transmitting apparatus is arranged in the plug housing in order to tap the signal at the signal conductor,

wherein a first cable plug can be plugged into the first plug part, which first cable plug is connected to a first cable on the sensor side, which cable is connected to or can be connected to the sensor, wherein a second cable plug can be plugged into the second plug part of the plug housing, which second cable plug is connected to a second cable on the supply side, which cable is connected to or can be connected to the supply apparatus (for example with a machine control system, pump control system or the like).

It is about the tapping of a signal between a first apparatus and a second apparatus via a compact adapter plug. The first apparatus is a sensor with which a measurement signal is produced. The second apparatus or supply apparatus is preferably a control apparatus and/or a supply apparatus, for example a PLC control system of a machine. In this respect, the disclosure relates in particular to a mechanical apparatus, which has at least one machine, one machine control system and one measuring device for transmitting or monitoring a machine parameter, wherein the sensor is connected to the machine control system with at least one line or one cable. According to the disclosure, the adapter plug is integrated into this line, that is to say the measuring apparatus or the sensor is connected to the machine control system (a PLC, for example) via the adapter plug according to the disclosure, by plugging the first cable plug of the first cable (which is connected to the sensor) into or onto the first plug part of the plug housing and by the second cable plug of a second cable (which is connected, for example, to the machine control system or another supply apparatus for the sensor) being plugged into or onto the second plug part of the adapter plug. The mechanical apparatus can in particular be a pump apparatus, which has a pump, a pump control system and a measuring apparatus, wherein the measuring apparatus can, where appropriate, be part of the pump or is integrated into it.

The disclosure is based on the realisation that the possibility of wireless signal transfer or signal interrogation via radio technologies, for example, can be integrated particularly simply into mechanical installations and in particular also existing mechanical installations via a compact, in design terms very simply constructed adapter plug, which on the one hand is equipped with standard plug parts on a plug housing and into the plug housing of which on the other hand the complete functionality for tapping and transmitting the sensor signal is integrated. Therefore, in particular an electronic circuit for tapping the signal and a transmitter (with antenna) are arranged within the plug housing, which is permanently equipped with the plugs or plug parts. Such an electronic transmitting apparatus can be realised as a so-called radio chip with integrated microcontroller and corresponding analogue or digital circuitry for tapping the sensor signal. The adapter plug is looped into the sensor line or the cabling (between the sensor and the supply apparatus), and the radio chip with microcontroller can be used to tap the sensor signal and provide the sensor signal as a radio signal, for example a Bluetooth signal or mobile radio signal. Thus, the tapped signals, for example sensor data, can be sent into the cloud either directly or via a gateway. According to the disclosure, modern radio technologies are consequently integrated into an adapter plug with standard plug connections, so that this adapter plug can be integrated very favourably as an adapter between the electronic apparatuses, for example between the measuring apparatus and the control system, without any significant cabling outlay. The adapter plug can be installed easily and, in particular, also retrofitted into existing installations, for example existing pump installations or pumps, so that signals are available wirelessly in a simple way, without negatively affecting the wired cabling or wiring of the measuring apparatuses with the control system. In particular, as a result, the control operations which are often achieved in real time, in which the sensors are connected to the control system by cable, are not affected. This saves on recabling or new cabling and reduces assembly times.

Particularly important is the fact that a very compact adapter plug with the complete functionality for tapping and transmitting the sensor signals is made available, which is preferably equipped with standard plugs. Preferably, one of the plug parts is formed as a male plug part (i.e., as a plug) and the other plug part is formed as a female plug part (i.e., as a socket). Particularly preferably, known (standardised) standard plug parts are used, for example known and standardised round plug connectors. Therefore, use is made in particular of M12 round plug connectors with screw locking, which are standardised, for example, in accordance with DIN EN 61076-2-101:2013. Thus, an M12 adapter plug in particular is made available.

A particular advantage of the solution according to the disclosure, with the adapter plug according to the disclosure, is the fact that the supply of power to the transmitting apparatus integrated into the plug housing takes place exclusively via the cables which can be plugged into the plug part or into the plug parts. As a consequence, no additional power supply is integrated into the plug housing and it is also not necessary to connect an additional power supply to the plug housing. In this respect, it is particularly preferably envisaged that the plug housing has, besides the first plug part and the second plug part or in addition to these plug parts, no further plug parts or connections for an additional power supply. Consequently, the adapter plug is supplied only via the ports of the connection between the supply apparatus and the sensor and preferably no additional current ports are envisaged. The disclosure is based on the realisation that, in the case of conventional sensors and the supply thereof or conventional control appliances to which such a sensor is connected, a normal voltage supply or current supply (24 V, for example) is provided, so that the sensor is supplied with the necessary power via its connection cable. This is possible both via a current line (4 to 20 mA, for example) as well as via a voltage line (24 V). This will be discussed later. The power supply intended for the sensor anyway is also used identically for the supply of the adapter plug and the electronic components arranged therein, in particular the electronic transmitting apparatus. Consequently, the voltage supply or current supply of the adapter plug is identically the same supply that is intended for the sensor.

In one possible, particularly simple embodiment, the sensor can be formed as a conventional (loop-powered) two-conductor sensor or two-wire sensor, which is connected to a 24 V supply apparatus and in which the signal is transferred with a conventional current intensity in a range of at least 4 mA to max. 20 mA. In the plug housing, (only) two signal conductors (an outward conductor and a return conductor) are provided between the first and second plug parts, which signal conductors at the same time are formed as supply conductors and consequently as conductors for the power supply and which are connected to the plug parts respectively. The electronic transmitting apparatus for tapping the signal is integrated into or onto one of these signal conductors. At the same time, a parasitic supply of voltage to the electronic transmitting apparatus takes place via this signal conductor, which at the same time serves as a supply conductor. Consequently, the adapter plug also uses the signal conductor for the power supply in the sense of a parasitic supply.

Alternatively, however, a three-conductor sensor or three-wire sensor can be also used as the sensor, wherein in this case a current-carrying signal conductor, a voltage-carrying supply conductor and a ground or neutral conductor are arranged in the plug housing between the first and second plug parts, these being connected to the two plug parts respectively. Such three-wire sensors are known both for a 4 to 20 mA wiring and for a 0 to 10 V wiring. Consequently, conventional sensors and conventional control systems or power supplies for the sensor are used and the adapter plug is adapted to the respective variant and can be used by simply plugging it in. Here, even in the case of such a three-wire sensor, an exclusively parasitic supply of power can take place via the sensor line. Alternatively, however, an active supply of voltage via the supply voltage from the control system or supply apparatus of the sensor can also be used. For details, reference should be made to the different variants in the description of the figures.

The adapter plug according to the disclosure can be configured both for analogue signal transfer and for digital signal transfer. Reference is also made to this in the description of the figures.

In particular, a radio signal, for example a Bluetooth signal or a mobile radio signal, is produced with the electronic transmitting apparatus, which can, for example, have a radio chip or be formed as a radio chip.

Optionally, one or more additional functional apparatuses, for example one or more additional sensors, can be integrated into the plug housing of the adapter plug. In this case, it can be a temperature sensor or a vibration sensor, for example. The signals produced with these additional functional apparatuses can likewise be transmitted wirelessly with the electronic transmitting apparatus, i.e., these signals measured within the adapter plug can also be interrogated remotely.

The disclosure relates to not only the device described, which is formed as an adapter plug, but it also relates to a measuring apparatus with such an adapter plug. In the context of the disclosure, measuring apparatus means the combination of, on the one hand, a sensor and, on the other hand, a supply apparatus (or a base appliance) for this sensor, wherein the adapter plug according to the disclosure is additionally provided, wherein the adapter plug is connected to the sensor with a first cable and to the supply apparatus with a second cable. In the simplest case, the supply apparatus can be a simple power supply for the sensor and consequently a simple measuring appliance that, besides the power supply, has an indicator (for example a visual and/or an audible indicator) for example, with which the values determined by the sensor can be represented visually or in another form. While the sensor is conventionally connected to such a supply apparatus (as a base appliance) with a classic cable, the adapter plug is interconnected according to the disclosure. In a preferred development, the supply apparatus is a control system (a PLC control system, for example). Traditionally, sensors are connected to such a control system with the aid of a classic cable. According to the disclosure, the adapter plug is interconnected.

In a preferred development, the disclosure relates to a mechanical apparatus with a machine and with such a measuring apparatus. The supply apparatus for the sensor is consequently formed as a machine control system or is integrated into such a machine control system (a PLC control system, for example). With the sensor, a machine parameter can be monitored, the machine control system being connected to the machine control system via the adapter plug.

Preferably, the adapter plug according to the disclosure is consequently used for mechanical apparatuses, pump apparatuses for example. In such a pump apparatus, the sensor is connected to the pump control system via a conventional cable with M12 plugs, for example. The adapter plug according to the disclosure can now be integrated very easily, with its M12 plug parts, into the cabling, whereby the first cable, for example the sensor cable, is plugged into the first M12 plug part with an M12 plug or socket, for example, and the second cable, for example the control cable (of the pump control system) is plugged into the second plug part, for example the M12 plug part, with an M12 plug/socket.

Particularly preferably, the disclosure can be used for eccentric screw pumps. Such an eccentric screw pump has at least one stator, one rotor rotating in the stator and one drive for the rotor. This is a pump from the group of rotary positive displacement pumps, which are used to convey a wide variety of media and in particular highly viscous liquids in a wide range of industrial sectors. The liquids to be conveyed can also contain solid contents, for example. Such eccentric screw pumps are known, for example, from DE 10 2008 021 920 A1, DE 10 2014 112 552 B4, DE 10 2014 112 550 B4 or DE 10 2016 121 582 A1. They are usually connected to a pump control system, which can be formed as a PLC (programmable logic controller), for example. The pump, moreover, can be equipped with different sensors, for example temperature sensors, pressure sensors or the like. In practice, these sensors are likewise connected to the pump control system, so that real-time control of the pump can take place as a function of the measured sensor signals. The adapter plug according to the disclosure can now be integrated into this connection between the sensor and the control system, so that the sensor signals are not only available in real time in the pump control system, but can also be tapped wirelessly in the manner described.

As described, conventional two-wire sensors or three-wire sensors are preferably used as the sensors. These can be pressure sensors, temperature sensors, flow sensors or the like.

### BRIEF DESCRIPTION OF THE DRAWINGS

The disclosure will be described below with the aid of drawings, which merely represent an example embodiment. In the drawings:
FIGS. 1A-1E illustrate, in a diagrammatically very simplified manner, different variants of a measuring apparatus according to the disclosure with an adapter plug according to the disclosure,
FIGS. 2A and 2B illustrate one possible embodiment of an adapter plug according to the disclosure in two different (perspective) views.

### DETAILED DESCRIPTION OF THE INVENTION

In FIGS. 1A to 1E, depicted in each case in a diagrammatically very simplified manner is a sensor 1, which is connected by wire to an (electronic) supply apparatus 2, for example to a control system 2. The sensor 1 can be a pressure sensor, for example. The supply apparatus or control system 2 can be a PLC control system, which is a component of a mechanical installation, for example a pump installation.

The sensor 1 is connected (by cable) to the control system 2 with the interconnection of a device 3, which serves for the wireless transmission of the analogue sensor signal. This device 3 is provided with electrical connections via which, on the one hand, the line or cable 10 from the sensor 1 and, on the other hand, the line or cable 12 from the control system 2 can be connected. Furthermore, the device has an electronic transmitting apparatus 8, which in turn, on the one hand, has an electronic circuit for tapping the sensor signal and, on the other hand, a transmitter, so that the tapped signal can be transmitted wirelessly with the transmitter.

According to the disclosure, the device 3 is formed as an adapter plug 3, which has a plug housing 4 to which a first plug part 5 and a second plug part 6 are attached. The first plug part 5 is connected to the second plug part 6 via at least one signal conductor 7, arranged within the plug housing 4, for wired transfer of the sensor signal. The electronic transmitting apparatus 8 already mentioned, with which the sensor signal is tapped from the signal conductor 7, is integrated into the plug housing 4.

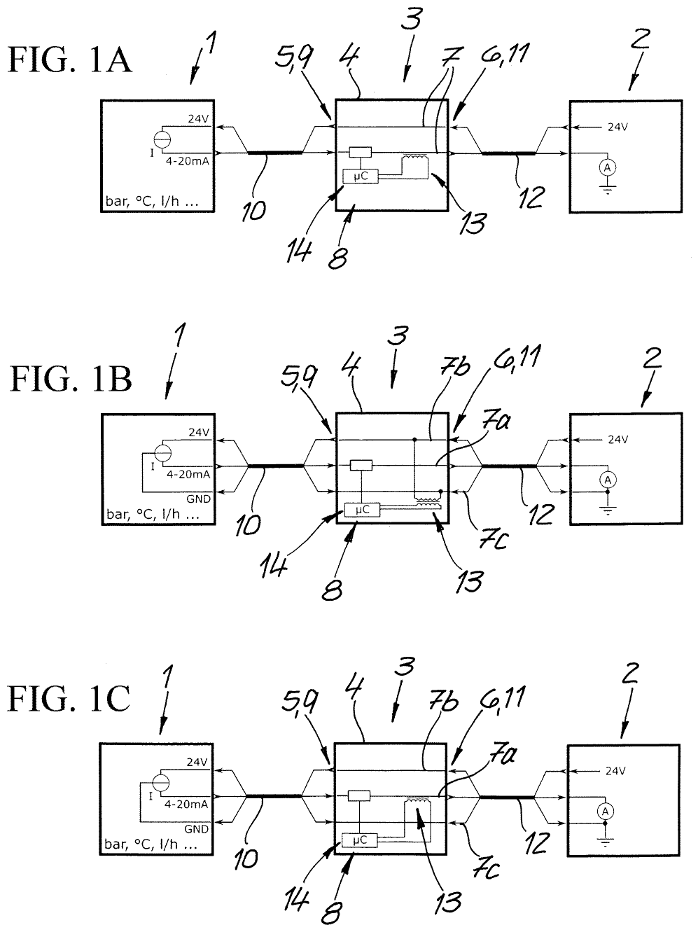

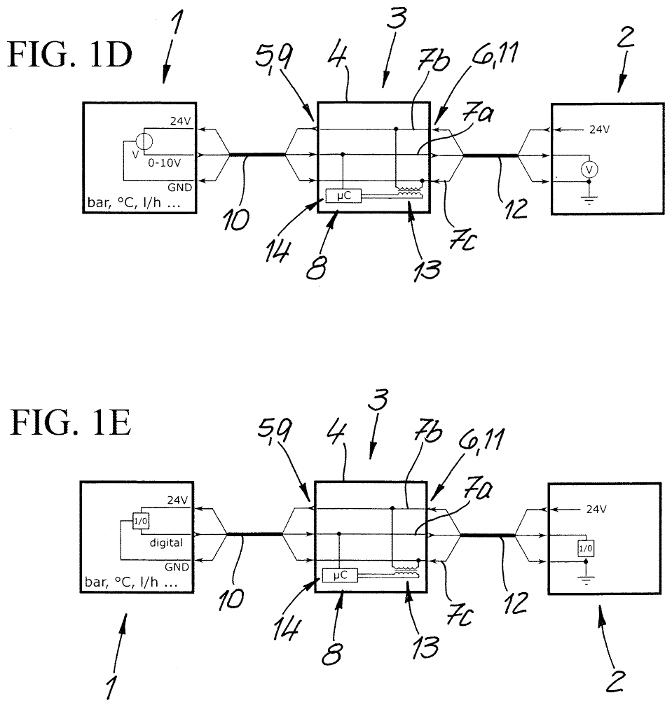

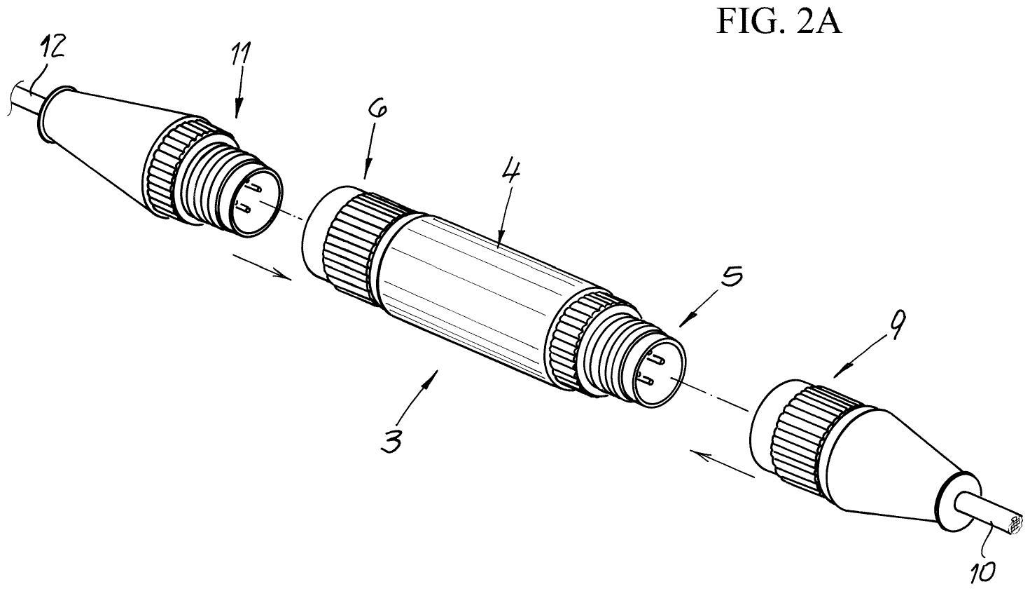

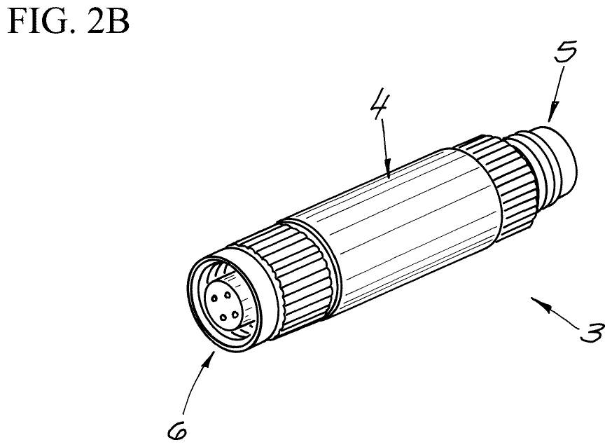

In this case, FIG. 2A shows that a first cable plug 9 can be plugged into the first plug part 5, which first cable plug 9 in turn is connected to a first line or a first cable 10, wherein this first cable 10 is connected to the sensor 1, for example.

Correspondingly, a second cable plug 11 can be plugged into the second plug part 6, which second cable plug 11 in turn is connected to a second line or a second cable 12. This second cable 12 can be connected to a second apparatus 2, for example, to the control system 2 for example.

A comparative viewing of FIGS. 1A to 1E and 2A and 2B makes it clear that, in a generally known pump installation, the measuring apparatus or sensor 1 can be connected directly to the control system 2 via conventional standard plug connectors (without the device 3). The adapter plug 3 according to the disclosure can now be integrated very simply, and without wiring outlay, into this/these connecting line(s) between the sensor 1 and the control system 2. This basically maintains a wired connection between the measuring apparatus 1 and the control system 2 for faultless real-time control. However, the sensor signal transferred by wire can additionally be tapped electronically via the adapter plug 3 and made available for wireless remote interrogation via the electronic transmitting apparatus 8. The radio chip of the transmitting apparatus 8 can provide a Bluetooth signal or a mobile radio signal, for example, which transmits the tapped sensor data into the cloud either directly or via a gateway.

The plug parts 5, 6 of the adapter plug 3 are preferably formed as standard plug connectors, for example as M12 round plug connectors with screw locking. This is indicated in FIG. 2A in particular. Since also the cable plugs 9, 11 of the normal connecting cables 10, 12 and also the connecting lines for the sensor 1 and the control system 2 are equipped with such M12 round plug connectors, the adapter plug 3 can be integrated in a straightforward manner into existing installations. The adapter plug 3 can be incorporated into an (existing) installation with minimal installation time. It can be used universally, regardless of the specific configuration of the control system.

Moreover, it is expedient if one of the plug parts, for example the first plug part 5, is formed as a male plug part and the other plug part, for example the second plug part 6, is formed as a (complementary) female plug part (cf. FIGS. 2A, B).

It is particularly important, within the context of the disclosure, that the supply of power to the transmitting device 8 integrated into the plug housing 4 takes place exclusively via the cables 10, 12 which are provided anyway, so that no additional power supply is integrated into the plug housing 4. Also no additional power supply is connected to or can be connected to the plug housing 4, meaning that the plug housing 4 has no further plug parts or connections, in addition to the first plug part 5 and the second plug part 6, for an additional power supply. The supply of power always takes place via the supply apparatus 2 of the sensor 1 and consequently via the connection cable 10 or 12 that is provided anyway. This is true for all the depicted example embodiments in FIGS. 1A to 1E, which will be discussed in greater detail hereinafter.

FIG. 1A shows a first embodiment of the disclosure with a conventional loop-powered 4 to 20 mA two-wire sensor, which is normally connected to a supply apparatus or a corresponding control system with a 24 V connection. In the interconnected adapter plug 3 or in the plug housing 4 thereof, only the two signal conductors 7 are arranged between the first plug part 5 and the second plug part 6, which two signal conductors 7 at the same time serve as supply conductors for a parasitic power supply of the electronic transmitting apparatus 8. Therefore, in FIG. 1A it is indicated that the electronic transmitting apparatus 8 for tapping the sensor signal is integrated into one of the signal conductors 7 or connected to one of these signal conductors 7. This is typically an integrated circuit 14 that, on the one hand, taps the signal of the signal line and, on the other hand, is equipped with a radio chip with which a radio signal, for example a Bluetooth signal or a mobile radio signal, can be produced. Also indicated in FIG. 1A is the parasitic power supply 13 for the transmitting apparatus 8 or the integrated circuit 14. The voltage supply of the adapter plug 3 is consequently generated from the current that the sensor 1 superimposes, without affecting the measurement signal itself.

FIGS. 1B to 1E show different variants of a three-wire sensor.

In FIG. 1B, a variant with a (current-driven) 4 to 20 mA three-wire sensor is depicted. The three-wire sensor has, in addition to the current-carrying signal conductor 7a, a voltage-carrying 24 V line 7b and a ground line 7c. FIG. 1B shows an embodiment in which the transmitting apparatus 8 in the adapter plug 3 is actively supplied with a voltage via the 24 V line 7b, so that a voltage supply is produced independently of the current superimposed from the sensor 1. An active voltage supply such as this enables a higher transmission power or a kind of intermediary node, which could pass on the data packets from more distant adapter plugs, indeed as far as to a data gateway. However, also in this active variant, the supply of power takes place exclusively via the cables 10 or 12 with which the sensor 1 is connected to the control system 2. Additional voltage supplies or connections are not provided at the adapter plug 3. In this embodiment, on the one hand a current-carrying signal conductor 7a, on the other hand a voltage-carrying supply conductor 7b and finally a ground or neutral conductor 7c are consequently arranged in the plug housing 4 between the first plug part 5 and the second plug part 6, which in each case are connected to the plug parts 5, 6. The electronic transmitting apparatus 8 taps the measurement signal from the signal conductor 7a. The supply of voltage to the electronic circuit 14 takes place via the voltage-carrying supply conductor 7b and the ground conductor 7c.

FIG. 1C shows a 4 to 20 mA three-wire sensor. The sensor 1 according to FIG. 1C and the control system 2 thereof are consequently depicted identically as in the embodiment according to FIG. 1B. In contrast to the embodiment according to FIG. 1B, however, the supply of power to the adapter plug 3 in the embodiment according to FIG. 1C again takes place parasitically and therefore not actively. The power supply of the adapter plug in the variant according to FIG. 1C is consequently comparable with the variant according to FIG. 1A.

FIG. 1D shows an embodiment of a three-wire sensor, which is not a 4 to 20 mA sensor however, but rather is formed as a (voltage-driven) 0 to 10 V sensor. In this respect, the measurement of the measurement variable differs from the previously described embodiments, since a voltage measurement is carried out and not a current measurement. The supply of voltage to the adapter plug, however, again takes place actively via the 24 V line 7b, that is to say actively via the control system or via the cables 10, 12.

Finally, an embodiment of a digital three-wire sensor is depicted in FIG. 1E, and indeed again with active voltage supply via the 24 V line 7b of the control system 2. The sensor 1 consequently offers a digital interface, for example a Modbus or an IO link, which can be read out from the adapter plug 3.

The disclosure is always characterised by the easy-to-integrate adapter plug 3.

Such an adapter plug is characterised by compact design and simple cabling via conventional M12 round plugs, for example.

It is within the scope of the disclosure that the plug housing 4 has a length of less than 10 cm, preferably less than 7 cm, for example up to 5 cm. The length preferably means the extension along the longitudinal direction, which extends for example from the first plug part 5 to the second plug part 6. In the case of a box-shaped housing, the width and/or the height are each less than 5 cm, preferably less than 3 cm, for example up to max. 2 cm. Preferably, a cylindrical plug housing is produced, which has a length in the dimension described and a diameter of less than 5 cm, preferably less than 3 cm, for example up to 2 cm.

What is claimed is:

1. A device for wireless transmitting a signal transferred from a sensor to a supply apparatus via a line, with electrical connections and an electronic transmitting apparatus, the electronic transmitting apparatus having an electronic circuit for tapping the signal from the line and a transmitter, with which the tapped signal can be wirelessly transmitted,
wherein the device is formed as an adapter plug having a plug housing,
wherein a first plug part and a second plug part are attached to the plug housing,
wherein the first plug part is connected to the second plug part via a signal conductor arranged within the plug housing for wired transfer of the signal,
wherein the electronic transmitting apparatus is arranged in the plug housing in order to tap the signal from the signal conductor, and
wherein a first cable plug is plugged into the first plug part, the first cable plug being connected to a first cable on a sensor side of the first cable plug, and wherein a second cable plug is plugged into the second plug part, the second cable plug being connected to a second cable on a supply side of the second cable plug.

2. The device according to claim 1, wherein the supply apparatus is a supply and indicator apparatus with a visual and/or audible indication of a measurement signal.

3. The device according to claim 1, wherein the supply apparatus is a supply and control apparatus with a control system of a machine.

4. The device according to claim 1, characterised in that the plug housing has a length of less than 10 cm and/or a width less than 5 cm.

5. The device according to claim 4, wherein the length of the plug housing is less than 7 cm and/or the width of the plug housing is less than 3 cm.

6. The device according to claim 1, characterised in that the first and second plug parts are formed as mutually corresponding, complementary plug parts, wherein the first plug part is formed as a male plug part and the second plug part is formed as a complementary female plug part.

7. The device according to claim 1, wherein the first plug part and/or the second plug part are formed as round plug connectors.

8. The device according to claim 7, wherein the first plug part and/or the second plug part are formed as M12 round plug connectors with a screw locking.

9. The device according to claim 1, wherein supplying power to the electronic transmitting apparatus integrated into the plug housing takes place exclusively via a cable that can be plugged into the first and second plug parts, wherein no additional power supply is integrated into the plug housing and/or no additional power supply can be connected or is connected to the plug housing.

10. The device according to claim 1, wherein the plug housing, outside of besides the first plug part and the second plug part, is absent of further plug parts or connections configured to provide an additional power supply.

11. The device according to claim 1, wherein the sensor is formed as a two-conductor sensor such that two signal conductors are provided in the plug housing between the first and second plug parts, the two signal conductors being formed simultaneous to supply conductors and are connected to the first and second plug parts.

12. The device according to claim 1, characterised in that the sensor is formed as a three-conductor sensor, wherein a current-carrying signal conductor, a voltage-carrying supply conductor, and a ground conductor or neutral conductor are arranged in the plug housing between the first and second plug parts, and wherein the current-carrying signal conductor, the voltage-carrying supply conductor, and the ground conductor or the neutral conductor are connected to the first and second plug parts.

13. The device according to claim 1, wherein the electronic transmitting apparatus is configured to produce a radio signal.

14. The device according to claim 13, wherein the radio signal is a Bluetooth signal or a mobile radio signal produced via a radio chip.

15. The device according to claim 1, wherein an additional functional apparatus is integrated into the plug housing, and wherein a signal produced with the additional functional apparatus is transmitted wirelessly with the electronic transmitting apparatus.

16. The device according to claim 15, wherein the additional functional apparatus is a temperature sensor or a vibration sensor.

17. A measuring apparatus comprising the device according to claim 1, the sensor, and the supply apparatus, wherein the adapter plug of the device is connected to the sensor with a first cable and is connected to the supply apparatus with a second cable.

18. A mechanical apparatus comprising a machine and the measuring apparatus according to claim 17, wherein the supply apparatus is formed as a machine control system or is integrated into a machine control system, wherein a machine parameter is monitored with the sensor, and wherein the machine control system is connected to the sensor via the device.

19. The mechanical apparatus according to claim 18, wherein the mechanical apparatus is formed as a pump apparatus including a pump, the machine control system formed as a pump control system, and the sensor for determining or monitoring an operating parameter of the pump.
